(19) United States
(12) Patent Application Publication
(10) Pub. No.: US 2025/0189424 A1
(43) Pub. Date: Jun. 12, 2025

(54) SYSTEM AND METHOD FOR REAL-TIME DETERMINATION OF PARTICLE SIZE DISTRIBUTIONS IN DRY POWDERS

(71) Applicant: Massachusetts Institute of Technology, Cambridge, MA (US)

(72) Inventors: Qihang Zhang, Cambridge, MA (US); Ajinkya Pandit, Cambridge, MA (US); Allan S. Myerson, Cambridge, MA (US); George Barbastathis, Boston, MA (US); Janaka C. Gamekkanda Gamaethige, Quincy, MA (US); Richard D. Braatz, Arlington, MA (US); Zhen Guo, Cambridge, MA (US)

(21) Appl. No.: 18/845,766

(22) PCT Filed: Nov. 16, 2022
(86) PCT No.: PCT/US2022/050045

§ 371 Date: Sep. 10, 2024

Related U.S. Application Data
(60) Provisional application No. 63/318,880, filed on Mar. 11, 2022.

(51) Int. Cl. G01N 15/0205; G01N 15/0227

(52) U.S. Cl. CPC G01N 15/0211; G01N 15/0227

(57) ABSTRACT

A method of monitoring a particle size distribution (PSD) is provided. A plurality of particles having a particle size distribution (PSD) may be illuminated by an at least partially coherent beam to produce scattered light. The scattered light may be captured by a pixelated photoelectric detector, thereby creating an ensemble of raw speckled images. Based on the ensemble of the raw speckled images. an ensemble-averaged intensity correlation may be computed. The ensemble-averaged intensity correlation may be provided to an inverse module. The inverse module may be configured to determine the PSD based on the ensemble-averaged intensity correlation. The particle size distribution may be obtained from the inverse module.

### CROSS-REFERENCE TO RELATED APPLICATIONS

This application claims the benefit of U.S. Provisional Application No. 63/318,880 filed Mar. 11, 2022, which is hereby incorporated by reference in its entirety.

### BACKGROUND

Many pharmaceuticals undergo a drying stage, during which the wet solid, or “cake”, is converted into a powder consisting of particles with the requisite size distribution. These powders are subsequently encapsulated into solid dosage forms/pills.

Agitation filter dryer (AFD) is one of the most common dryers used in the industry since it integrates both filtration and drying unit operations are integrated into one equipment. However, the formation of aggregates during the drying process has become a challenging problem because of unbreakable hard lumps and product degradation due to the trapped moisture in the powder. During the drying process, the temperature and pressure (vacuum) are controlled (depending on the solvent used and the temperature stability of the solid) and the cake is agitated or intermittently agitated to prevent unwanted agglomeration. Even though the parameters of the drying processes and the overall industrial environments where these processes take place are generally well controlled, the evolution of the particle sizes during agitation is not fully predictable. Particle size distribution (PSD) in cakes may range from a few 1 micron to 1000 microns with the possibility of even larger agglomerates forming. The goal of the drying process is to maintain the initial particle size and to prevent ‘hard agglomerates’ (crystals bonded together) from forming. The presence of large hard agglomerates is undesired as they can cause content uniformity issues in drug formulation and can cause a batch to be rejected for not meeting PSD specifications. Even though the breaking of hard aggregates is possible in some cases, the delumping of the powder requires additional equipment and time, and it adds cost to the process. In the end, the delumping process also can result in loss of products. Thus, it is crucial to monitor the evolution of particle sizes quantitatively and in real time, to detect the beginnings of agglomeration as early as possible and correct through feedback control on process parameters (e.g., temperature, agitation speed).

No real-time online monitoring methods exist presently that can detect and prevent such abnormally large agglomerants early on. Imaging by a standard camera from a distance compatible with the manufacturing setting (˜0.5-1m away from the powder) does not provide sufficient spatial resolution to extract the PSD. Probe-based imaging with the fiber bundle is invasive and it only captures a very small field of view; thus, it may miss large agglomerates forming elsewhere; moreover, there is a risk of the powder obscuring the viewing field, rendering the imaging operation impossible. Instead, manufacturers commonly rely on trained personnel to visually observe the mixing-but this can be subjective. Machine vision to analyze the appearance of the cake surfaces and detect agglomerates are generally limited. Alternatively, it is possible at fixed time intervals to extract a sample from the cake and pass it through a particle size analyzer instrument. However, this method is invasive and slow and, thus, not suitable for industrial use.

Extracting quantitative information about highly scattering surfaces from an imaging system is a challenging problem because the phase of the scattered light undergoes multiple folds upon propagation, resulting in complex speckle patterns.

The speckle is an encoding of spatially variant patterns on the cake surface, which include particle locations and sizes. However, no explicit relationships exist to allow easy inverse mapping from the speckle to the statistical properties of the spatially variant particle features.

BRIEF SUMMARY

In an example embodiment, the present invention is a method of monitoring a particle size distribution (PSD). The method comprises illuminating a plurality of particles having a particle size distribution (PSD) by an at least partially coherent beam to produce scattered light; capturing the scattered light by a pixelated photoelectric detector, thereby creating an ensemble of raw speckled images; based on the ensemble of the raw speckled images, computing an ensemble-averaged intensity correlation; providing the ensemble-averaged intensity correlation to an inverse module, the inverse module being configured to determine the PSD based on the ensemble-averaged intensity correlation; and obtaining from the inverse module the PSD.

In another example embodiment, the present invention is a device for monitoring a particle size distribution (PSD). The device comprises an illumination module adapted to illuminate a plurality of particles having a particle size distribution (PSD) by an at least partially coherent beam to produce scattered light; a pixelated photoelectric detector configured to capture the scattered light and create an ensemble of raw speckled images; a correlation-computing module configured to compute an ensemble-averaged intensity correlation based on the ensemble of the raw speckled images; and an inverse module configured to determine the PSD based on the ensemble-averaged intensity correlation.

In yet another example embodiment, the present invention is a computer program product for monitoring a particle size distribution (PSD). The computer program product comprises a computer readable storage medium having program instructions embodied therewith, the program instructions executable by a processor to cause the processor to perform a method comprising: illuminating a plurality of particles having a particle size distribution (PSD) by an at least partially coherent beam to produce scattered light; capturing the scattered light by a pixelated photoelectric detector, thereby creating an ensemble of raw speckled images; based on the ensemble of the raw speckled images, computing an ensemble-averaged intensity correlation; providing the ensemble-averaged intensity correlation to an inverse module, the inverse module being configured to determine the PSD based on the ensemble-averaged intensity correlation; and obtaining from the inverse module the PSD.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIGS. 1(a)-1(d) illustrate a speckle probe and related optics, raw speckle and endoscope camera images, and a sketch of a powder model according to various embodiments of the present disclosure.

FIGS. 2(a)-2(d) depict microscope, raw speckle, spatial-integral autocorrelation images for two samples of KCl powder of different sizes as well as average autocorrelation according to various embodiments of the present disclosure.

FIGS. 3(a)-3(c) depict a deep convolutional neural network structure, an example associated cumulative distribution function (CDF), and example particle size distribution (PSD) curves according to various embodiments of the present disclosure.

FIGS. 4(a)-4(b) depict example test results including PSDs for a trained deep convolutional network utilizing various test sets according to various embodiments of the present disclosure.

FIG. 5 is a block diagram of a general-purpose computer which processes computer programs using a processing system according to various embodiments of the present disclosure.

FIG. 6 depicts a flow diagram of an example process for monitoring a particle size distribution (PSD) according to various embodiments of the present disclosure.

FIG. 7 depicts a schematic diagram of an example device for monitoring a particle size distribution (PSD) according to various embodiments of the present disclosure.

### DETAILED DESCRIPTION

The present disclosure provides methods, systems, and computer program products for monitoring a particle size distribution (PSD). Various embodiments of the present disclosure are discussed in detail below. While specific implementations are discussed, it should be understood that this is done for illustration purposes only. A person skilled in the relevant art will recognize that other components and configurations may be used without parting from the spirit and scope of the disclosure.

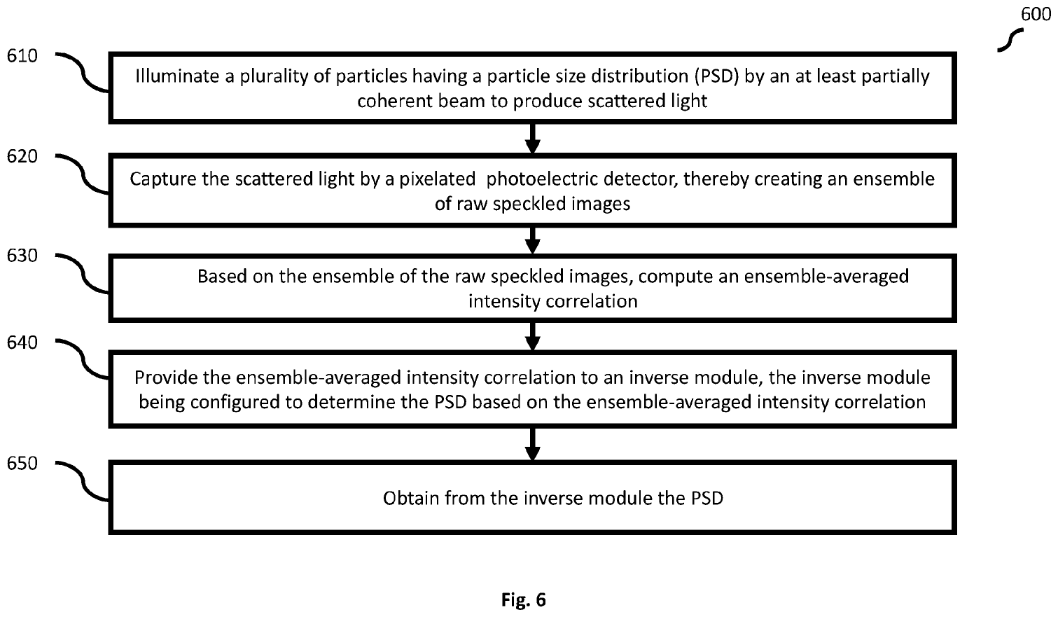

In a first example embodiment, a method of monitoring a particle size distribution (PSD) is provided. The first example embodiment is illustrated in FIG. 6, which shows a flow chart of an example method 600. In step 610, a plurality of particles having a particle size distribution (PSD) is illuminated by an at least partially coherent beam to produce scattered light. In step 620, the scattered light is captured by a pixelated photoelectric detector, thereby creating an ensemble of raw speckled images. In step 630, based on the ensemble of the raw speckled images, an ensemble-averaged intensity correlation is computed. In step 640, the ensemble-averaged intensity correlation is provided to an inverse module. The inverse module is configured to determine the PSD based on the ensemble-averaged intensity correlation. In step 650, the particle size distribution is obtained from the inverse module.

As used herein, “a partially coherent beam” refers to a beam that includes multiple coherent modes in space and/or time, wherein the modes can be mutually incoherent.

As used herein, a “pixelated” detector includes a class of digital or analog detector where the information is returned in the form of samples called “pixels.” The samples may be based on a sampling scheme, which may include uniform sampling, non-uniform sampling, masked sampling, and/or random sampling. For uniform sampling, the spacing between pixel locations is substantially constant. For non-uniform sampling, the spacing between pixel locations varies according to a predetermined formula, e.g. quadratic (also known as “linear chirp”) and/or other schemes. Masked sampling is a technique where samples are skipped (or blocked) according to a predetermined scheme, e.g. every second or every third pixel. Masked sampling can be physically implemented by superimposing an absorbing mask over the detector or at an image-conjugate plane. Random sampling is a technique where the pixel locations are determined according to a random number generator obeying a pre-chosen probability distribution. Although the examples and figures described herein are based on a uniform sampling scheme, what is presented herein may be implemented according to any the other sampling schemes, such as the sampling schemes described herein, without departing from the scope and spirit of what is described herein.

In various aspects of the first example embodiment, the ensemble-averaged intensity correlation may be an ensemble-averaged intensity autocorrelation. In further aspects, the inverse module may include a machine learning module, a gradient descent module, a non-linear solver, a curve-fitting module, or a differential evolution algorithm module. In an example embodiment, the inverse module may be configured to generate the PSD. In another example embodiment, the inverse module may be configured to generate a cumulative distribution function (CDF) and to differentiate the CDF to generate the PSD.

In various aspects of the first example embodiment, the inverse module may include the machine learning module. In further aspects, the machine module may include a neural network. Providing the ensemble-averaged intensity correlation to the inverse module may include providing the ensemble-averaged intensity correlation to the neural network configured to determine the PSD. In some aspects, the neural network may be a convolutional neural network. The convolutional neural network may include, for example, at least one skip connection. In other example embodiments, the convolutional neural network may include a plurality of stages. Each stage of the plurality of stages may include at least one skip connection and at least one batch-normalization and activation layer. In some aspects, the convolutional neural network may include a linear layer.

In various aspects of the first example embodiment, the plurality of particles may be a dry powder. The dry powder may be ground. Grinding the plurality of particles may be discontinued when the PSD shows agglomeration. The plurality of particles may be a wet powder. The wet powder may be agitated. Agitating the plurality of particles may be discontinued when the PSD shows agglomeration.

As used herein, “differentiating the CDF” to produce a PSD involves taking the first derivative of the CDF to produce the PSD.

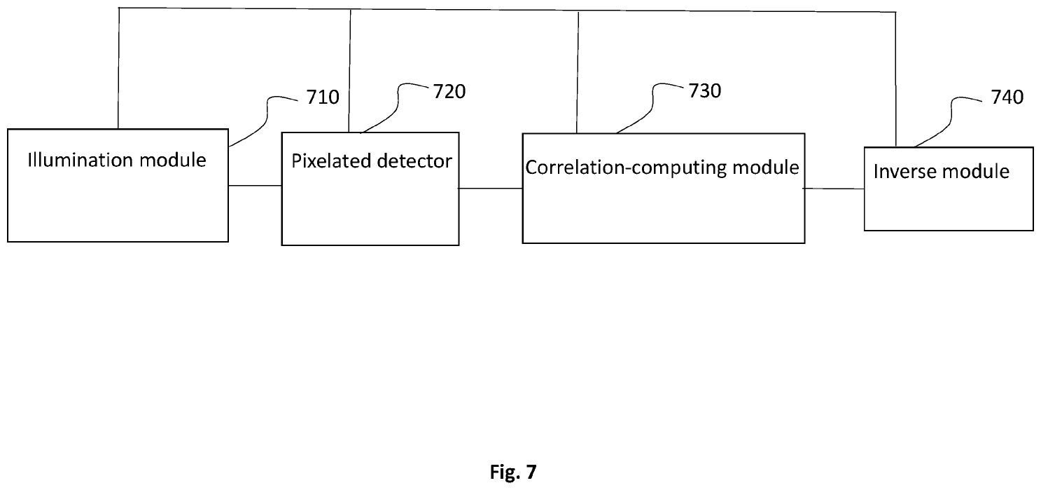

In a second example embodiment, a device is provided for monitoring a particle size distribution (PSD). The second example embodiment is illustrated in FIG. 7, which shows a schematic diagram of an example device 700. In one aspect of the second example embodiment, the device comprises: an illumination module (710) that is adapted to illuminate the plurality of particles having a particle size distribution (PSD) by an at least partially coherent beam to produce scattered light; a pixelated photoelectric detector (720) that is configured to capture the scattered light and create an ensemble of raw speckled images; a correlation-computing module (730) that is configured to compute an ensemble-averaged intensity correlation based on the ensemble of the raw speckled images; and/or an inverse module (740) configured to determine the particle size distribution based on the ensemble-averaged intensity correlation.

In various aspects of the second example embodiment, the correlation-computing module may be configured to compute an ensemble-averaged intensity autocorrelation. In certain aspects, the inverse module may include a machine learning module, a gradient descent module, a non-linear solver, a curve-fitting module, or a differential evolution algorithm module. In further aspects, the inverse module may be configured to generate the PSD. In other aspects, the inverse module may be configured to generate a cumulative distribution function (CDF) and to differentiate the CDF to generate the PSD.

In certain aspects of the second example embodiment, the inverse module may include the machine learning module. For example, the machine learning module may include a neural network. In some aspects, the neural network may be configured to determine the PSD. The neural network may be a convolutional neural network. In further aspects, the convolutional neural network may include at least one skip connection. In yet further aspects, the convolutional neural network may include a plurality of stages. Each stage of the plurality of stages may include at least one skip connection and at least one batch-normalization and activation layer. In additional aspects, the convolutional neural network may include a linear layer.

In certain aspects of the second example embodiment, the device may include a grinder adapted to grind the plurality of particles. The grinder may be adapted to transmit the at least partially coherent beam for illumination of the plurality of particles. In additional aspects, the device may include an agitator adapted to agitate the plurality of particles. The agitator may be adapted to transmit the at least partially coherent beam for illumination of the plurality of particles.

In a third example embodiment, a computer program product for monitoring a particle size distribution (PSD) is provided. The computer program product includes a computer readable storage medium having program instructions embodied therewith. The program instructions are executable by a processor to cause the processor to perform a method defined herein above with respect to the first example embodiments and various aspects thereof. For example, a plurality of particles having a particle size distribution (PSD) is illuminated by an at least partially coherent beam to produce scattered light. The scattered light is captured by a pixelated photoelectric detector, thereby creating an ensemble of raw speckled images. Based on the ensemble of the raw speckled images, an ensemble-averaged intensity correlation is computed. The ensemble-averaged intensity correlation is provided to an inverse module. The inverse module is configured to determine the PSD based on the ensemble-averaged intensity correlation. The PSD is obtained from the inverse module.

In various embodiments, the devices and methods disclosed herein employ machine learning (ML)-assisted speckle analysis to quantitative real-time monitoring of mixing and drying processes. In various embodiments, one application of such processes may be the drying of powder suspensions and wet powders (“cakes”) in the pharmaceutical industry, where quantifying the PSD is of particular interest. The system and method disclosed herein may not, however, be limited to such processes; other possible applications may include other pharmaceutical processes such as milling, and powder blending, rheological measurements in complex fluids or emulsions, characterization, and characterization of cell growth processes for personalized medicine, and/or other applications.

The speckle is an encoding of spatially variant patterns on the cake surface, which can include particle locations and sizes. However, conventionally no explicit relationships exist to allow an easy inverse mapping from the speckle to the statistical properties of the spatially variant particle features. Disclosed herein are (i) methods and systems that produce a speckle from light scattered by a powder in a chemical drying process that carries sufficient information to extract the PSD in the cake; and (ii) methods and systems for processing the speckle registered on a pixelated photoelectric detector, such as a CCD or CMOS camera, to obtain the PSD quantitatively.

In various embodiments, methods are provided. In the disclosed methods, a cake may be illuminated by a laser beam. The light scattered from the cake surface may be captured by a pixelated photoelectric detector, such as a CCD or CMOS camera. These captured image data may be referred to as the “raw speckle image.” The raw speckle image may be processed. Using the optical propagation equation, the relationship between the PSD and the ensemble-averaged autocorrelation of captured raw speckle images may be established. The camera may capture the raw speckle images, and may transmit them to a dedicated digital computer, in-house or in the cloud, which may perform the computations necessary to obtain the PSD quantitatively. The methods disclosed herein may be used both for training a machine learning (ML) algorithm, which may be equivalently referred to as an ML model/module, and/or for regular operation in the industrial or laboratory environment. The digital computer may first compute the ensemble-averaged intensity autocorrelation function of the raw speckle image and forward it to an ML model/module. If the ML model/module, such as a DNN, is in training mode, ground truth data may be used to specify the weights in the ML model/module such that it outputs the correct PSD matching the ground truth training data. After training, the ML model/module, such as a DNN, may be capable of receiving the ensemble-averaged autocorrelations as input and producing the correct PSD as output, reliably and with fast computation. Such methods are capable of increased interpretability, compared to conventional “black box” deep learning approaches, since the input to the ML model/module, such as a DNN, may be shaped by physical law, namely the ensemble-averaged autocorrelation of the raw speckle images. Such methods, as presented herein, have been validated using a commercial particle size analyzer to independently establish the PSD and match it to the results of the disclosed ML approach. Additional details about the disclosed methods and possible embodiments are included in section 3, below.

In various embodiments, systems are provided. In the disclosed systems, in various embodiments, the laser and CCD camera (or alternative photoelectric detector) are mounted on a frame such that the light scattered from the cake is effectively captured. The “common path” configuration, described in detail in section 3 below, may be preferred because it maximizes the light capturing efficiency. The camera may capture the raw speckle images, and may transmit them to a dedicated digital computer, in-house or in the cloud, which may performs the methods and/or computations described herein, such as in the previous paragraph. The disclosed system may be used both for training the ML algorithm and/or for regular operation in the industrial or laboratory environment. The digital computer may first compute the ensemble-averaged intensity autocorrelation function of the raw speckle image and may forward it to the ML model/module. If the ML model/module, such as a DNN, is in training mode, ground truth data may be used to specify the weights in the ML model/module such that it outputs the correct PSD matching the ground truth training data. After training, the ML model/module, such as a DNN, may be capable of receiving the ensemble-averaged autocorrelations as input and producing the correct PSD as output, reliably and with fast computation. Such systems are capable of increased interpretability, compared to conventional “black box” deep learning approaches since the input to the ML model/module, such as a DNN, may be shaped by physical law, namely the ensemble-averaged autocorrelation of the raw speckle images. Such systems, as presented herein, have been validated with a laboratory prototype operating under conditions closely emulating the conditions encountered in industry, using a commercial particle size analyzer to independently establish the PSD and match it to the results of the disclosed ML approach. Additional details about the disclosed methods and possible preferred embodiments are included in section 3, below. One purpose of the methods and systems, as disclosed herein, may be to overcome limitations of conventional techniques by providing a real-time, minimally invasive, and easily deployable in the industrial setting instrument to monitor particle size distributions quantitatively. The methods and systems disclosed herein are based on physics and algorithms, so they do not involve human intervention and/or human subjectivity. The algorithms operate faster and more efficiently as compared to conventional techniques because the algorithms include a component based on ML, which after training may not be computationally demanding. The ML algorithm may perform computations during the training phase, which may occur during the design of the algorithm, and which may insignificantly or not impact the user.

### From Speckle to Distributions of Powder Particle Sizes

The methods and systems, as described herein, use one or more images of a speckle, which may be an encoding of the particle sizes. A speckle image results from propagation of a wavefront whose phase has been strongly modulated by spatially variant features across a surface and/or a volume. According to the Huygens principle, the influence of each feature upon its neighbors expands as the propagation distance increases. Interference from light scattered by each feature with its neighbors results in a “salt and pepper” appearance of a speckle at any observation screen downstream, such as the viewer's retina or a digital camera. For a fixed rough surface, a speckle may technically be deterministic, because it may entirely be determined by the surface morphology. However, because the surface morphology is seldom known and/or very difficult to determine, and it is difficult to compute the scattered light exactly, traditional analysis of a speckle treats the surface morphology as a random process in the spatial domain. As long as the morphology statistics are invariant, it may be straightforward to relate statistical moments of the surface to the statistical moments of the speckle itself.

The speckle has long been used to characterize surface roughness, but the conventional techniques to characterize surface roughness only work when the surface height fluctuation, or equivalently, typical particle size, is smaller or comparable than the light wavelength. This limits its application to surfaces encountered in many industrial processes, such as pharmaceuticals manufacturing. Electronic Speckle Pattern Interferometry (ESPI) is another conventional technique that can measure the surface motion distribution even at nanometer scales. However, ESPI requires a reference beam, and it is disadvantageously is a two-step measurement that cannot detect absolute height. Another conventional technique, laser speckle contrast imaging, is qualitative and does not yield quantitative results on the surface roughness. Yet another conventional technique, interferometric particle imaging, can measure the particle size and shape, but only works for a single particle or sparse distributed particles.

The methods and systems disclosed herein treat the speckle as a nonlinear superposition of roughness whose statistics vary with position on the surface. The map includes the complexities of mixing-drying dynamics and speckle formation, as noted earlier; thus, it is may not always be practical to invert it directly. Instead, an inverse module, which may include a machine learning (ML) algorithm assisted by the physics of speckle formation, may be applied.

In recent years, ML algorithms have been used in imaging through scattering media and in speckle suppression. Speckle surface analysis, which focuses on the scattering media itself may be assisted by an ML algorithm, such by performing classifications to distinguish different materials. Due to the surface randomness and the phase sensitivity, it may be difficult for an ML algorithm, such as a neural network to capture key features. In the methods and systems disclosed herein, the speckle image may be preprocessed according to the beam propagation equations to enhance the essential features to reduce the burden on the ML module and/or model. From the theory and equations, such as equation (24), disclosed herein, the ensemble averaged spatial-integral autocorrelation function can be used to build a forward model from the statistics of powder surface, the PSD, to the processed image. In various embodiments, the ML model/module, which may use a DNN that is a deep convolution neural network, may be used to learn the inverse mapping from the averaged autocorrelation image to the PSD. The forward model is made more interpretive using physics, as seen below. The forward model may allow for the bounds of the prediction ability to be known. In some cases, this may be a difficult to determine using black-box algorithms, such as those using ML models.

Drying cakes made up of multiple particles of varying sizes, such as powders, typically include surfaces that are rough, which may be due to the presence of powders. As a cake is agitated and gradually dries, the particles tend to agglomerate to a wide range of sizes, from a few micrometers to a few millimeters. These particles are distributed all across the cake surface and move rapidly due to the agitation. As a result, the surface roughness statistics are also strongly variant across the cake surface and with time. The process of speckle formation described herein may be used to encode the complex dynamics of mixing and drying of the cake and/or particles.

Although the descriptions herein may refer to ML models/modules performing various operations, in various embodiments, these models/modules may be included within an inverse module, which may alternatively or additionally include a gradient descent module, a non-linear solver, a curve-fitting module, or a differential evolution algorithm module as components. In various embodiments, the operations, functionality, and/or configurations of the ML models/modules described herein can be equivalently attributed to the inverse module and/or any one or more components within the inverse module without departing from the scope and spirit of what is described herein.

One or more computers can be used to implement such a computational pipeline, using one or more general-purpose computers, such as client devices including mobile devices and client computers, one or more server computers, or one or more database computers, or combinations of any two or more of these, which can be programmed to implement the functionality such as described in the example implementations.

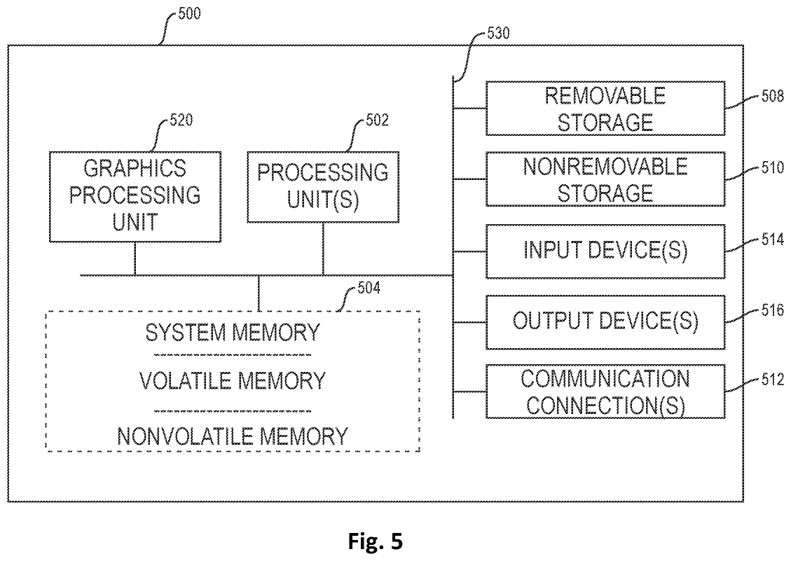

FIG. 5 is a block diagram of a general-purpose computer which processes computer programs using a processing system. Computer programs on a general-purpose computer generally include an operating system and applications. The operating system is a computer program running on the computer that manages access to resources of the computer by the applications and the operating system. The resources generally include memory, storage, communication interfaces, input devices and output devices.

Examples of such general-purpose computers include, but are not limited to, larger computer systems such as server computers, database computers, desktop computers, laptop, and notebook computers, as well as mobile or handheld computing devices, such as a tablet computer, handheld computer, smart phone, media player, personal data assistant, audio and/or video recorder, or wearable computing device.

With reference to FIG. 5, an example computer 500 comprises a processing system including at least one processing unit 502 and a memory 504. The computer can have multiple processing units 502 and multiple devices implementing the memory 504. A processing unit 502 can include one or more processing cores (not shown) that operate independently of each other. Additional co-processing units, such as graphics processing unit 520, also can be present in the computer. The memory 504 may include volatile devices (such as dynamic random-access memory (DRAM) or other random-access memory device), and non-volatile devices (such as a read-only memory, flash memory, and the like) or some combination of the two, and optionally including any memory available in a processing device. Other memory such as dedicated memory or registers also can reside in a processing unit. Such a memory configures is delineated by the dashed line 504 in FIG. 5. The computer 500 may include additional storage (removable and/or non-removable) including, but not limited to, solid state devices, or magnetically recorded or optically recorded disks or tape. Such additional storage is illustrated in FIG. 5 by removable storage 508 and non-removable storage 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory devices, and removable and non-removable storage devices. Memory 504, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 500 may also include communications connection(s) 512 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 512 are devices, such as a network interface or radio transmitter, that interface with the communication media to transmit data over and receive data from signals propagated through communication media.

The communications connections can include one or more radio transmitters for telephonic communications over cellular telephone networks, and/or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 500 may have various input device(s) 514 such as various pointer devices (whether single pointer or multi-pointer), such as a mouse, tablet and pen, touchpad and other touch-based input devices, stylus, image input devices, such as still and motion cameras, audio input devices, such as a microphone. The compute may have various output device(s) 516 such as a display, speakers, printers, and so on, also may be included. These devices are well known in the art and need not be discussed at length here.

The various storage 510, communication connections 512, output devices 516 and input devices 514 can be integrated within a housing of the computer or can be connected through various input/output interface devices on the computer, in which case the reference numbers 510, 512, 514 and 516 can indicate either the interface for connection to a device or the device itself as the case may be.

An operating system of the computer typically includes computer programs, commonly called drivers, which manage access to the various storage 510, communication connections 512, output devices 516 and input devices 514. Such access generally includes managing inputs from and outputs to these devices. In the case of communication connections, the operating system also may include one or more computer programs for implementing communication protocols used to communicate information between computers and devices through the communication connections 512.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

Each component (which also may be called a “module” or “engine” or “computational model” or the like), of a computer system such as described herein, and which operates on one or more computers, can be implemented as computer program code processed by the processing system(s) of one or more computers. Computer program code includes computer-executable instructions and/or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

### Theory of the Forward Problem

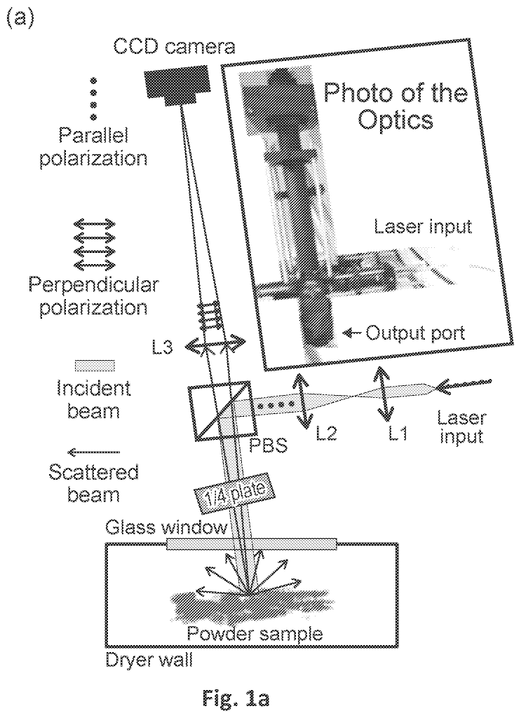

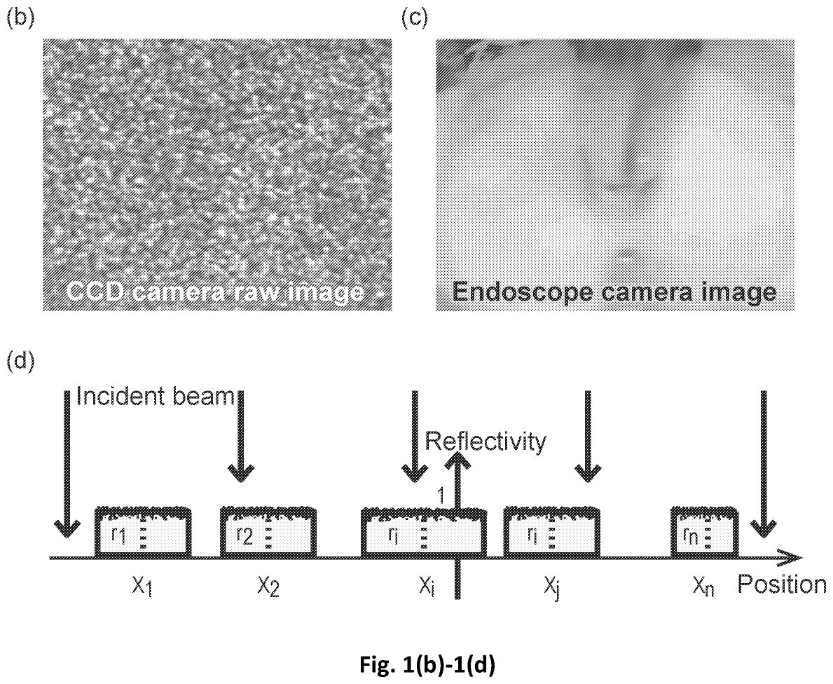

To find the relationship between the speckle pattern and the PSD, a simplified one-dimensional (1D) analytical model was built. FIG. 1(d) shows the sketch of the model. Only the first layer was considered, because the light comes from the top. An assumption was made that only particles can scatter the light. Without the loss of generality, the reflectivity was set to 1. The sketch considers the particles as an optical mask denoted as a(x).

The particle radius rᵢ is interpreted as a random variable distributed according to the PSD p(r). The particle location xᵢ is a random variable uniformly distributed across the object plane. H(x) describes the surface height resulting from the randomly placed particles. The corresponding phase of the scattered light is

$$w ( x ) = exp ( j \frac{2 π}{λ} H ( x ) ) .$$

From optical propagation theory, the electric field E(x) at the imaging plane is

$$E ( x ) = \int {e}^{j \frac{2 π}{λ {f}_{3}} x ξ} S ( ξ ) d ξ , \qquad ( 1 )$$

$$where$$

$$S ( ξ ) = a ( x ) w ( x ) , \qquad ( 2 )$$

and f₃ is the focal length of lens L3. The intensity collected by the CCD camera is

$$I ( x ) = {\vert E ( x ) \vert}^{2} = \int \int {e}^{j \frac{2 π}{λ {f}_{3}} x ( {ξ}_{1} - {ξ}_{2} )} S ( {ξ}_{1} ) {S}^{*} ( {ξ}_{2} ) d {ξ}_{1} d {ξ}_{2} . \qquad ( 3 )$$

We now define the spatial-integral autocorrelation of the speckle image as

$$A ( {u}^{′} ) = \int I ( x ) I ( x + {u}^{′} ) dx . \qquad ( 4 )$$

Substituting equations (2) and (3) into equation (4),

$$A ( {u}^{′} ) = \int \int \int \int \int {e}^{j \frac{2 π}{λ {f}_{3}} [ x ( {ξ}_{1} - {ξ}_{2} ) + ( x + {u}^{′} ) ( {η}_{1} - {η}_{2} ) ]} S ( {ξ}_{1} ) {S}^{*} ( {ξ}_{2} ) S ( {η}_{1} ) {S}^{*} ( {η}_{2} ) dxd {ξ}_{1} d {ξ}_{2} d {η}_{1} d {η}_{2} \qquad ( 5 )$$

After integrating over x,

$$\begin{matrix}A ( {u}^{′} ) = \int \int \int \int {e}^{j \frac{2 π}{λ {f}_{3}} {u}^{′} ( {η}_{1} - {η}_{2} )} S ( {ξ}_{1} ) {S}^{*} ( {ξ}_{2} ) S ( {η}_{1} ) {S}^{*} ( {η}_{2} ) \\ d {ξ}_{1} d {ξ}_{2} d {η}_{1} d {η}_{2} \int {e}^{j \frac{2 π}{λ {f}_{3}} ( {ξ}_{1} - {ξ}_{2} + {η}_{1} - {η}_{2} )} dx \\ = \int \int \int \int {e}^{j \frac{2 π}{λ {f}_{3}} {u}^{′} ( {η}_{1} - {η}_{2} )} S ( {ξ}_{1} ) {S}^{*} ( {ξ}_{2} ) S ( {η}_{1} ) {S}^{*} ( {η}_{2} ) \\ δ ( {ξ}_{1} - {ξ}_{2} + {η}_{1} - {η}_{2} ) d {ξ}_{1} d {ξ}_{2} d {η}_{1} d {η}_{2}\end{matrix} \qquad ( 6 )$$

The delta function is non-zero only when ξ₂=ξ₁+η₁-η₂. Then the equation can be further simplified as,

$$A ( {u}^{′} ) = \int \int \int \int {e}^{j \frac{2 π}{λ {f}_{3}} {u}^{′} ( {η}_{1} - {η}_{2} )} S ( {ξ}_{1} ) {S}^{*} ( {ξ}_{1} + {η}_{1} - {η}_{2} ) S ( {η}_{1} ) {S}^{*} ( {η}_{2} ) d {ξ}_{1} d {η}_{1} d {η}_{2} \qquad ( 7 )$$

From Equation (7), we do the variable substitution with η=η₂, σ=η₁−η₂ and τ=ξ₁−η₂.

$$\begin{matrix}A ( {u}^{′} ) = \int \int \int \int {e}^{j \frac{2 π}{λ {f}_{3}} {u}^{′} ( σ + η - η )} S ( η + τ ) \\ {S}^{*} ( σ + η + τ ) S ( η + σ ) {S}^{*} ( η ) d τ d σ d η \\ = \int d τ [ \int {e}^{j \frac{2 π}{λ {f}_{3}} {u}^{′} ( σ + η )} {S}^{*} ( σ + η + τ ) S ( σ + η ) d σ ] \\ [ \int {e}^{- j \frac{2 π}{λ {f}_{3}} {u}^{′} η} S ( η + τ ) {S}^{*} ( η ) d η ] \\ = \int d τ [ \int {e}^{j \frac{2 π}{λ {f}_{3}} {u}^{′} σ} {S}^{*} ( σ + τ ) S ( σ ) d σ ] [ \int {e}^{- j \frac{2 π}{λ {f}_{3}} {u}^{′} η} S ( η + τ ) {S}^{*} ( η ) d η ] \\ = \int d τ {\vert \int {e}^{j \frac{2 π}{λ {f}_{3}} {u}^{′} σ} S ( σ ) {S}^{*} ( σ + τ ) d σ \vert}^{2}\end{matrix} \qquad ( 8 )$$

$$Let u = \frac{2 π {u}^{′}}{λ {f}_{3}} ,$$

$$A ( u ) = \int d τ {\vert \int {e}^{ju σ} S ( σ ) {S}^{*} ( σ + τ ) d σ \vert}^{2} \qquad ( 9 )$$

After substituting S with equation (2),

$$A ( u ) = \int d τ {\vert \int {e}^{ju σ} a ( σ ) {a}^{*} ( σ + τ ) w ( σ ) {w}^{*} ( σ + τ ) d σ \vert}^{2} \qquad ( 10 )$$

In the internal integral over σ, the phase term

$$w ( σ ) = exp ( j \frac{2 π}{λ} H ( σ ) )$$

varies much faster than a(σ) and e^{juσ}, so the rotating wave approximation can be applied to move w(σ)w*(σ+τ) out of the integral over σ.

$$A ( {u}^{′} ) = \int d τ W ( τ ) {\vert \int {e}^{ju σ} a ( σ ) {a}^{*} ( σ + τ ) d σ \vert}^{2} \qquad ( 11 )$$

Where W(τ)=(w(σ)w*(σ+τ))_{σ}, is the spatial average of w(σ)w*(σ+τ) over σ. W(τ) describes spatial correlation of the surface phase, W(τ) will drop to 0 if τ is out of the correlation length. For the ideal rough surface, the correlation length is infinitely small, so that W(τ) degrades into δ(t). a(x) is the mask of particles, and a(x) can be defined using the following formulas.

$$a ( σ ) = Rect {\sum }_{i} ( \frac{σ - {x}_{i}}{{r}_{i}} ) \qquad ( 12 )$$

$$a ( σ ) {a}^{*} ( σ + τ ) = {\sum }_{i , j} Rect ( \frac{σ - {x}_{i}}{{r}_{i}} ) Rect ( \frac{σ - ( {x}_{j} - τ )}{{r}_{j}} ) \qquad ( 13 )$$

Because the particles cannot overlap, and the correlation length is well smaller than the particle size, it can approximately be assumed that

$$Rect ( \frac{σ - {x}_{i}}{{τ}_{i}} ) Rect ( \frac{σ - ( {x}_{j} - τ )}{{τ}_{j}} ) = 0$$

$$for$$

$$i \neq j .$$

$$a ( σ ) {a}^{*} ( σ + τ ) = {\sum }_{i} Rect ( \frac{σ - {x}_{i}}{{r}_{i}} ) Rect ( \frac{σ - ( {x}_{i} - τ )}{{r}_{i}} ) = {\sum }_{i} Rect ( \frac{σ - ( {x}_{i} + \frac{τ}{2} )}{{r}_{i} - \frac{τ}{2}} ) \qquad ( 14 )$$

After substituting equation (14) to equation (11),

$$A ( u ) = \int d τ W ( τ ) {\vert {\sum }_{i} \int {e}^{ju σ} Rect ( \frac{σ - ( {x}_{i} + \frac{τ}{2} )}{{r}_{i} - \frac{τ}{2}} ) d σ \vert}^{2} \qquad ( 15 )$$

The internal integral is the Fourier transform,

$$\int {e}^{ju σ} Rect ( \frac{σ - ( {x}_{i} + \frac{τ}{2} )}{{r}_{i} - \frac{τ}{2}} ) d σ = {e}^{- ju ( {x}_{i} + \frac{τ}{2} )} \frac{sin ( {u}^{′} ( {r}_{i} - \frac{τ}{2} ) )}{{u}^{′}} \qquad ( 16 )$$

$$A ( u ) = \int d τ W ( τ ) {\vert {\sum }_{i} {e}^{- ju ( {x}_{i} + \frac{τ}{2} )} \frac{sin ( {u}^{′} ( {r}_{i} - \frac{τ}{2} ) )}{{u}^{′}} \vert}^{2} \qquad ( 17 )$$

If the assumption that W(t)=δ(τ) is applied, equation (17) can be transferred into,

$$A ( u ) = {\vert {\sum }_{i} \frac{sin ( {r}_{i} u )}{u} {e}^{j 2 π {x}_{i} u} \vert}^{2} . \qquad ( 18 )$$

### Here,

$$u = \frac{{u}^{′}}{λ {f}_{3}} ,$$

i is the index of the i-th particle, and rᵢ and xᵢ are the radius and the position for the i-th particle, respectively. If there are enough particles in the field of view, equation (18) can be reformulated as

$$A ( u ) = {\vert \int dr p ( r ) \frac{sin ( ru )}{{u}^{′}} {\sum }_{i} {e}^{j 2 π {x}_{i} u} \vert}^{2} . \qquad ( 19 )$$

The term

$${\sum }_{i} {e}^{j 2 π {x}_{i} u}$$

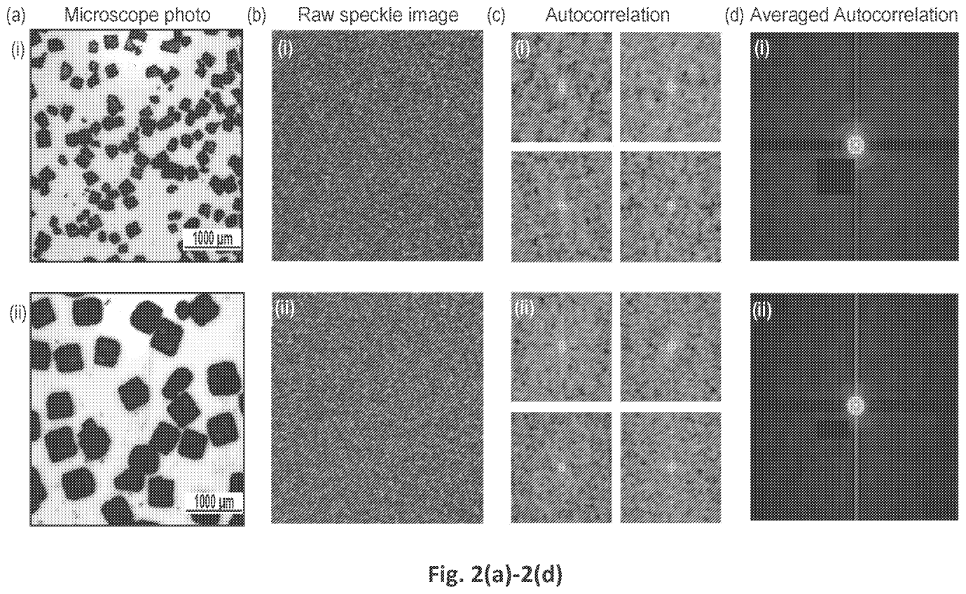

results from the granular feature in FIG. 2(c). Because the particle coordinate x is immaterial, it may be eliminated by ensemble averaging the autocorrelation (u). Starting from equation (17), since W(τ) is invariant, the ensemble average bracket can be moved into the integral,

$$\begin{matrix}〈 A ( u ) 〉 = \int d τ W ( τ ) 〈 {\vert {\sum }_{i} {e}^{- ju ( {x}_{i} + \frac{τ}{2} )} \frac{sin ( u ( {r}_{2} - \frac{τ}{2} ) )}{u} \vert}^{2} 〉 \\ = \int d τ W ( τ ) 〈 {\sum }_{i , j} {e}^{- ju [ ( {x}_{i} + \frac{τ}{2} ) - ( {x}_{j} + \frac{τ}{2} ) ]} \frac{sin ( u ( {r}_{2} - \frac{τ}{2} ) )}{u} \frac{sin ( u ( {r}_{2} - \frac{τ}{2} ) )}{u} 〉 \\ = \int d τ W ( τ ) \int p ( {r}_{1} ) p ( {r}_{2} ) \frac{sin ( u ( {r}_{2} - \frac{τ}{2} ) )}{u} \frac{sin ( u ( {r}_{2} - \frac{τ}{2} ) )}{u} {dr}_{1} {dr}_{2} 〈 {\sum }_{i , j} {e}^{- ju ( {x}_{i} - {x}_{j} )} 〉\end{matrix} \qquad ( 20 )$$

The third equal sign comes from the fact that r and x are independent. The radius rᵢ follows the probability distribution p(r) which is invariant. The xᵢ is randomly distributed in the space, and it is ergodic, so the ensemble average over x is equal to the spatial average,

$$〈 {\sum }_{i , j} {e}^{- ju ( {x}_{i} - {x}_{j} )} 〉 = \frac{1}{{D}^{2}} {\int }_{- \frac{D}{2}}^{\frac{D}{2}} {e}^{- ju ( {x}_{1} - {x}_{2} )} {dx}_{1} {dx}_{2} = \frac{4 {sin}^{2} \frac{Du}{2}}{{D}^{2} {u}^{2}} \qquad ( 21 )$$

D is the laser spot diameter

$$\frac{Du}{2} = π$$

term determines the average speckle size, which is consistent with the traditional results from a textbook.

$$\int p ( {r}_{1} ) ( {r}_{2} ) \frac{sin ( u ( {r}_{1} - \frac{τ}{2} ) )}{u} \frac{sin ( u ( {r}_{2} - \frac{τ}{2} ) )}{u} {dr}_{1} {dr}_{2} = {\vert \int p ( r ) \frac{sin ( u ( {r}_{2} - \frac{τ}{2} ) )}{u} dr \vert}^{2} \qquad ( 22 )$$

If equations (21) and (22) are substituted back to equation (20),

$$〈 A ( u ) 〉 = \frac{4 {sin}^{2} \frac{Du}{2}}{{D}^{2} {u}^{2}} \int d τ W ( τ ) {\vert \int p ( r ) \frac{sin ( u ( {r}_{2} - \frac{τ}{2} ) )}{u} dr \vert}^{2} \qquad ( 23 )$$

The particle size of a sample may vary from ˜50 μm to ˜1000 μm, which is much larger than the wavelength 532 nm. Thus, the criterion λ<<H(x) is met, implying that the phase correlation length is much smaller than the particle size. So, the assumption W(τ)=δ(τ) can be adopted safely. Then,

$$〈 A ( u ) 〉 = \frac{4 {sin}^{2} \frac{Du}{2}}{{D}^{2} {u}^{2}} {\vert \int p ( r ) \frac{sin ( u ( {r}_{2} - \frac{τ}{2} ) )}{u} dr \vert}^{2} . \qquad ( 24 )$$

Here, [symbol] · [symbol] denotes the ensemble average and D is the beam spot diameter.

Equation (24) is an intuitive yet approximate forward relationship between the raw speckle images and the PSD p(r) through the speckle autocorrelation function A(u). The goal is to invert this relationship, or rather eq. (24) and obtain p(r) from A(u), which is described below. To gain some insight into this inverse problem, in FIG. 2(a)-2(d) two examples of distinctly different particle distributions are shown. In these figures, the upper row (i) set shows a powder with size ˜180-250 um, while the lower row (ii) shows a ˜425-500 μm powder. Column (a) shows the microscope images for two samples. Column (b) shows the raw speckle images. With the naked eye, one cannot distinguish between these two samples based on these raw images alone. Column (c) shows four autocorrelation images calculated from column (b) according to equation (19). These four images correspond to the same r distribution p(r) but different xᵢ positions for each particle. Due to the xᵢ related terms, the ensemble invariant features determined by PSD cannot be distinguished. Column (d) shows the ensemble-averaged autocorrelation image corresponding to Equation (24). From Equation (24), the

$$\frac{sin ( ru )}{u}$$

term decays faster vs. u as the radius r grows. The intensity of the lobes is modulated by the

$$\vert \int p ( r ) \frac{sin ( u ( {r}_{2} - \frac{τ}{2} ) )}{u} dr \vert$$

term of Equation (24). The intensity of the first-order lobe is higher on the upper panel than on the lower panel. Moreover, the second-order lobe can be seen in the upper panel, but not in the lower panel.

### Algorithm Design for the Inverse Problem

To perform an inverse of Equation (24), inverse techniques may be used by an inverse module, which may also include one or more modules to perform one or more aspects of the inverse techniques. The inverse module may include a machine learning module that utilizes a machine learning model, a gradient descent module that uses a gradient descent technique, a non-linear solver, a curve-fitting module that performs a curve-fitting technique, or a differential evolution algorithm module that performs a differential evolution algorithm. Parameterization of the particle size distribution can help reduce the number of parameters to be determined, and accelerate the convergence of the technique used to determine the inverse. Parameterization of the particle size distribution may require prior knowledge regarding the distribution. For example, one way to parameterize distributions is as a “sum of humps,” such as a sum of Gaussians, or a sum of Lorentzians, and/or the like. For these ways to parameterize distributions may include parameters such as the amplitudes, widths, and locations of the hump functions. In various examples and figures described herein, an inverse module, which may include an ML model/module, takes one or more images as input and outputs cumulative distribution functions (CDFs) and/or particle size distributions (PSDs). In various examples and figures described herein, an ML model/module takes one or more images as input and outputs cumulative distribution functions (CDFs) and/or particle size distributions (PSDs). As such, for this machine learning model/module, the number of parameters equals the number of bins in the distribution.

The forward relationship in Equation (24) is highly nonlinear; moreover, some information for the PSD may be in the sidelobes and, hence, the solution may be disproportionately susceptible to detection noise and other disturbances. A wide variety of techniques exist for dealing with such inversions, such as those performed by an inverse module, including gradient methods, maximum likelihood, and others. As a general strategy to stabilize the solution against disturbances, some form of regularization may be employed. In typical situations, the most effective regularizing priors may be derived from sparsity arguments, which may also be referred to as compressed sensing. That is, the unknown function may first expressed in a set of basis functions where it becomes sparse, meaning that very few coefficients are non-zero. For linear inverse problems, sparse formulations lead to convex functionals that may be numerically dealt with using methods such as TwIST and ADMM.

From Equation (24), some information may be in the sidelobes of the PSD, namely when the agglomerate sizes become very large. This suggests that sparsifying the PSD as, for example, a superposition of radial basis functions, may be risky. Instead, an inverse module approach, such as one using machine learning, using data from the experiment and the independent particle size analyzer may be used to determine and/or learn the regularizing prior. The algorithm(s) used by the inverse module may not be purely data-driven—it may take the physical forward model of Equation (24) explicitly into account as disclosed below. In various embodiments, the inverse module may use a machine learning algorithm/model/module, such as a deep neural network (DNN) which can be a deep convolutional neural network, to determine the regularizing prior. In various embodiments, the use of a physical forward model such as the one in Equation (24) as a preprocessor to an inverse module, such one using a neural network to perform the inverse may be described as an Approximant. In such embodiments, the learning approach simplifies extending the simple 1D analysis to two dimensions (2D), taking into account that particles may overlap along the longitudinal direction, and rectifying the deviation induced by the finite spatial integral and finite frames average in the ensemble autocorrelation calculation.

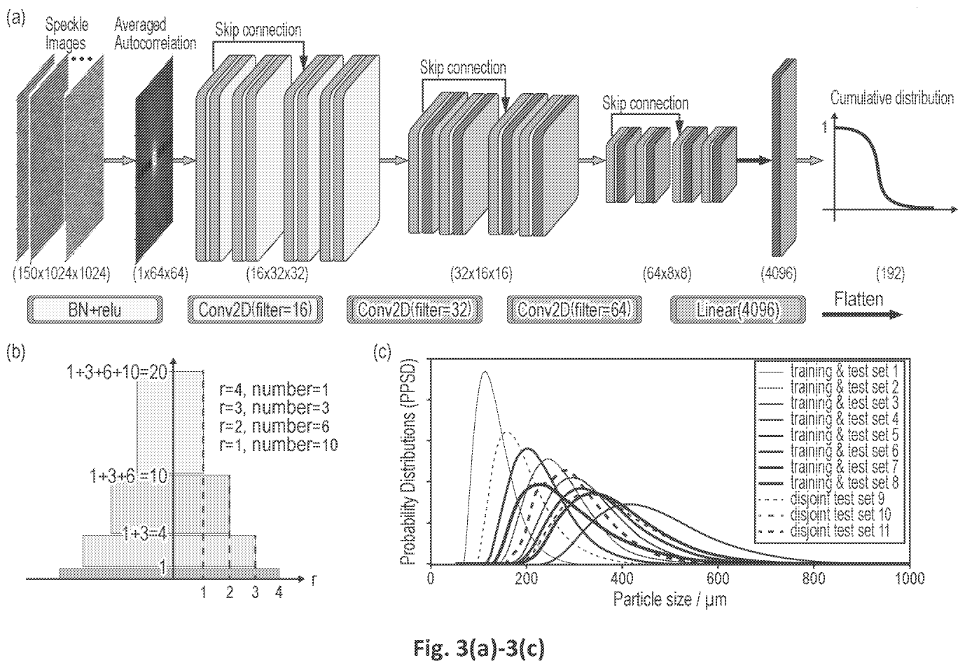

An example inverse module implementation of a neural network module using a deep learning architecture is shown in FIG. 3(a). Starting from a speckle video, such as one that is 150 frames, 1024 height by 1024 width, the autocorrelations may be calculated, which may be 150 frames, 64 height by 64 width. Employing an ergodicity argument, the autocorrelations may be averaged to obtain the ensemble intensity autocorrelation, which may be 64 height by 64 width. The computed autocorrelation may serve as the input of the inverse module, such as the input of a neural network, i.e., it is the Approximant, as shown in FIG. 3(a). The neural network, as shown, includes three convolutional stages followed by a linear layer. Each stage has four 2D convolutional layers of kernel size 3, combined with Batch-normalization layer and “ReLU” activation. At each stage, the first convolution layer has a stride equal to 2 to down sample the image. The filter depth increases gradually in each stage from 16 to 64. The skip connection structure can reduce the gradient vanishing effect. After three convolution stages, the 3D signal is flattened and passed through a linear layer to the output, which is non-parametric curve described by 192 samples. This is the cumulative distribution function of the particle sizes, which can then be differentiated to obtain the PSD.

There are two reasons the cumulative distribution function may be used herein rather than the PSD directly as the output of the neural network. First, the cumulative distribution is monotonic from 0 to 1, which discourages overfitting the fluctuations that would inevitably appear in the PSD. Second, the cumulative distribution may easily be derived from Equation (24) as

$$FT ( \int p ( r ) \frac{sin ( ru )}{u} dr ) ( x ) = \int p ( r ) rect ( \frac{x}{r} ) dr = {\int }_{0}^{\vert x \vert} p ( r ) dr \qquad ( 25 )$$

where rect(x)=1 when

$$x ∈ [ - \frac{1}{2} , \frac{1}{2} ] ,$$

otherwise=0 is the boxcar function. The physical meaning of the right-hand term in (25) is shown in FIG. 3(b). In effect, it moves all particles to the center, and the vertical axis becomes the number of particles as function of r. After normalization, it becomes exactly the cumulative distribution. Moreover, this physical meaning applies to any particle shape besides round particles, it easily generalizes to the rotationally averaged cumulative size distributions for non-rotationally symmetric cases, such as the cubic-shaped KCl powder particles shown in FIG. 2(a).

To train the neural network shown in FIG. 3(a), 11 sets of powder sample were prepared. For each set, a video with 1000 frames was collected. With the 500 fps CCD camera, each video collection takes only 2 seconds. 150 frames were used on average with a 50-frame step to get 17 ensemble autocorrelations. As shown in FIG. 3(c), a master-sizer measures the ground truth PSD. The master-sizer measurement limits the number of datasets that can be collected, as it is material-consuming and unrecyclable.

To evaluate the generalization ability of the DNN model, shown in FIG. 3(a), 8 sets of samples were separated to form the training and test set, whereas the remaining 3 sets (see FIG. 3(c)) were the disjoint test set. At each training and test set, 10 ensemble autocorrelations served as the training data, while the remaining 7 formed the test data. Training lasted for 60 epochs with mean absolute error (MAE) as the training loss function. The learning rate was set to be 10⁻³ initially and halved whenever validation loss plateaued for 5 consecutive epochs. Batch size was set to 4. The computer used for training has Intel Xeon G6 CPU, 128 GB RAM, and dual Volta GPUs with 64 GB VRAM.

Although deep neural network and deep convolutional neural network ML algorithms/models/modules are referenced herein, it should be understood that any ML algorithm/model/module may be used without departing from the scope and spirit of what is described herein. In particular, in various embodiments, the ML algorithms/models/modules may include a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural network, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, a deep Q-network, and/or the like. The ML algorithms/models/modules described herein may additionally or alternatively comprise weak learning models, linear discriminant algorithms, logistic regression, and the like. The ML algorithms/models/modules described herein may include supervised learning algorithms, unsupervised learning algorithms, reinforcement learning algorithms, and/or a hybrid of these algorithms.

### EXEMPLIFICATION

The experiments described below with reference to the figures were conducted using devices and methods described herein.

### FIGURES

FIG. 1(a) depicts a schematic diagram of an example optical train that can be employed by methods and devices disclosed herein. In the example embodiment depicted, lenses L1, L2, and L3 can have focal lengths of 25 mm, 30 mm, and 250 mm, respectively. The inset shows the photo of an experimental apparatus used in the experiments described hereinbelow. FIG. 1(b) is a photograph of an example raw speckle image collected from a CCD camera of the device. FIG. 1(c) is a photographic image collected from an endoscope camera. The white powder in the middle is the sample (KCl). FIG. 1(d) is a schematic diagram showing the reflection of an incident beam off of a powder comprising particles (depicted as rectangles), the particles located at positions xi and having radius rᵢ. The rough top edge of each particle (rectangle) means that the phase of the scattered beam varies randomly with the position xᵢ.

Two samples of KCl powder were tested using the devices and methods described herein: (i) a sample powder having particle size of about 180-250 μm and (ii) a sample powder having particle size of about 425-500 μm. FIG. 2(a) shows microscope images for the two samples. FIG. 2(b) shows raw speckle images of the two samples collected by a CCD camera. FIG. 2(c) shows examples of four spatial-integral autocorrelation images calculated from the images shown in FIG. 2(b). These four images were collected on the same sample with different particle positions. FIG. 2(d) shows the images of autocorrelation averaged over 150 frames such as those shown in FIG. 2(c). Since the particle position is ergodic, this is the ensemble-average autocorrelation image.

FIG. 3(a) schematically depicts an example embodiment of a deep neural network structure. The neural network shown in FIG. 3(a) takes averaged autocorrelation images as input and the cumulative distributions as output. It consists of three stages with four convolutional layers in each. Batch-normalization and ReLU activation are applied before each convolutional layer. There is a flatten layer and a linear layer connected to the output of the third stage. The output data dimension and the filter parameters for each layer are labeled at the bottom of this figure.

FIG. 3(b) is a schematic diagram showing the physical meaning of an example cumulative distribution function. Assuming there are 20 particles, ten particles have radius 1, six particles have radius 2, three particles have radius 3, and one particle has radius 4. If these are stacked at the center and set the y-axis as the particle number, this may be the cumulative distribution after a normalization.

FIG. 3(c) show overlayed plots of example PSDs as functions of particle size obtained for various test sets. There are 11 sample sets, 8 of them marked with green color are the training and test sets, while the rest three sets plotted in red are the disjoint test sets. The interest size range is 80 μm-800 μm, which is covered by the sample sets.

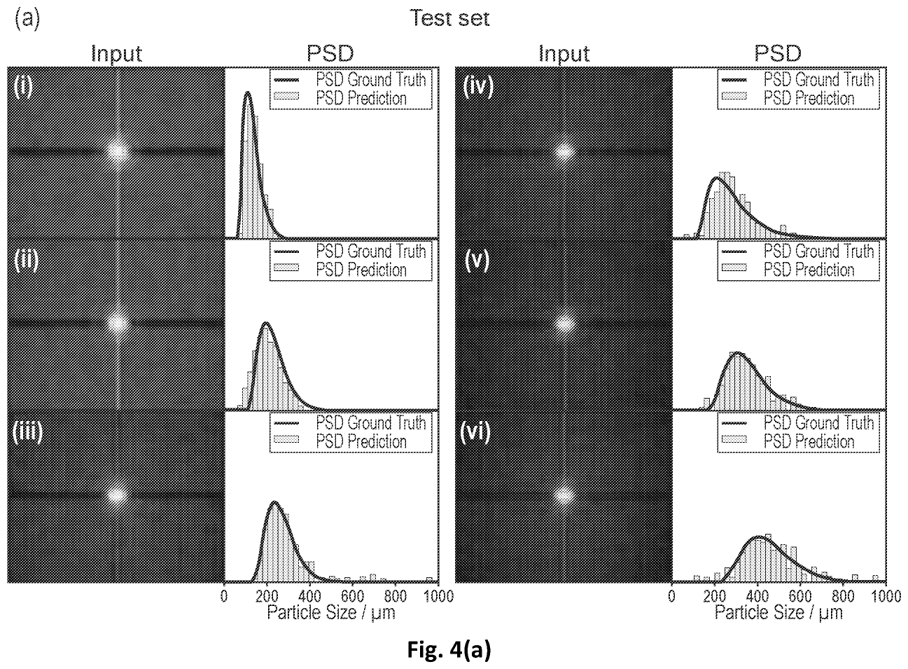

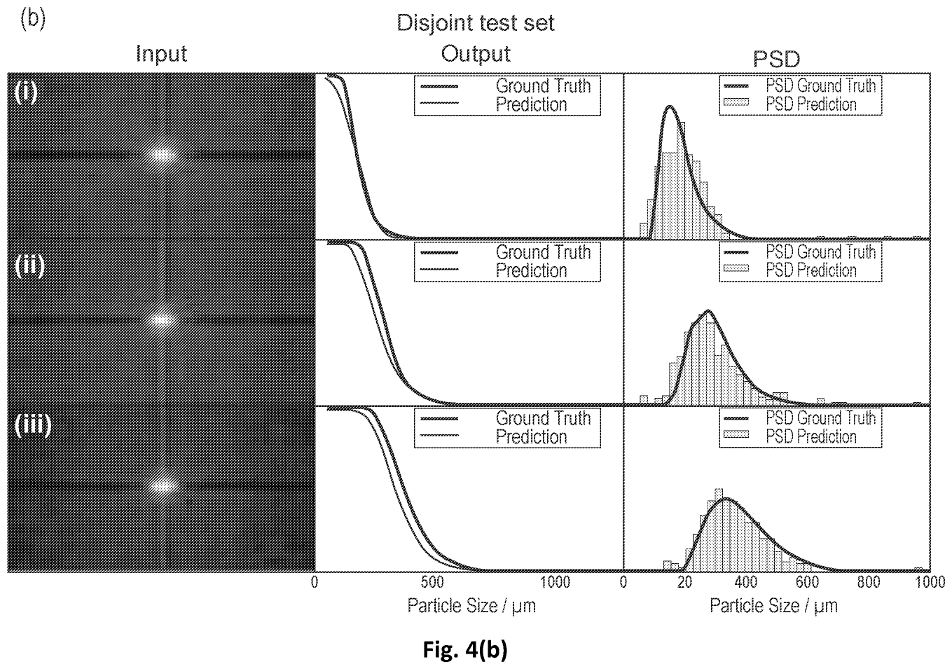

FIG. 4(a) shows test results for the neural network trained as described in section titled “Algorithm design for the inverse problem” for six different inputs labelled as (i)-(vi). The images in the left columns are the ensemble-averaged autocorrelations that served as inputs, and the bar plots in the right columns are the predicted PSDs. The curves represent the ground truth.

FIG. 4(b) shows the deep neural network (DNN) results obtained for the disjoint test sets. The first and third columns from the left are the same as those for inputs (i)-(iii) in FIG. 4(a), while the second column shows the neural network output prediction which is the cumulative distribution, which is differentiated to get the particle size distribution.

### Example Embodiments

In various embodiments, an air filter dryer (AFD) typical of those used in the pharmaceutical industry may be used to dry a wet solid, such as a cake. The wet solid may be sealed in the dryer, and it may be monitored non-invasively with a laser beam delivered through a glass window. An agitator placed along the axis of the container may impel the sample at a rotation speed of 5 rpm.

A laser beam operating at a particular wavelength, such as at a 532 nm wavelength, may illuminate the wet solid. In various embodiments, the laser model may need a sufficient output power and temperature rising rate, which may be low enough to not disturb the drying process for the duration of observation. In addition, the coherence length of the laser and the corresponding temporal bandwidth may be set to produce a sufficient temporal coherence and thus to produce sharp speckles. Additionally, the angle of incidence on the surface may be chosen so as to avoid specular back reflection from the window onto the camera. For example, the laser model may be an Excelsior 532 Single Mode with 300 mW output power, inducing a 1.2 mK/s temperature rising rate, which may be low enough to not disturb the drying process for the duration of observation. As another example, the coherence length of the laser may be 25 m, which corresponds to a temporal bandwidth of 0.01 pm. This may result in sufficient temporal coherence to produce sharp speckles. The angle of incidence on the surface is chosen to be approximately 10 degrees, so as to avoid specular back reflection from the window onto the camera.

An example optical train is shown in FIG. 1(a). In this example embodiment, the laser beam may be expanded, such as to 4.8 mm, with a beam expander in the telescope configuration, consisting of lenses L1 and L2. The beam may initially be polarized in the direction parallel to the plane shown in the diagram, and so it may be reflected by the polarizing beam splitter (PBS) to reach the sample inside the dryer through the glass window. Passage twice through the quarter wave plate rotates the outgoing polarization direction from parallel to perpendicular so that the scattered light from powder sample may now be now transmitted through the PBS and propagates vertically upwards. The wave plate may also be tilted, such as by approximately 10 degrees, for the same reason as the beam, to minimize specular back reflection.

Lens L3 may concentrate the scattered light so that an angular range that is as large as possible can be captured by the CCD. FIG. 1(b) shows a typical speckle image collected by the CCD camera. In some examples, the CCD model is Basler A504k with 1280×1024 pixels. The central uniformly illuminated area may be cropped, such as to 1024×1024 pixels. The framerate may be fast enough to avoid temporal blurring of the speckle due to the agitation. In some examples, the framerate is 500 fps and the exposure time may be 100 μsec, which may be fast enough to avoid temporal blurring of the speckle due to the agitation. The inset of FIG. 1(a) is a picture of an example apparatus as it may be implemented. For safety, the entire beam path may be enclosed in an optical cage and optical tubes to prevent scattered light from escaping. The structure of this optics apparatus may be compact and portable, and it may therefore be easy to transfer among different dryer systems without the need to realign. FIG. 1(c) is an image of a powder sample KCl collected by an endoscope camera, with broadband and spatially incoherent illumination. The resolution in FIG. 1(c) may be too coarse to resolve the particle size, not displaying any discernible features that could be attributed to particle size. This may explain why the speckle method is more appropriate for extracting the PSD, as discussed herein.

The data processing strategy for the raw speckle images collected by the apparatus of FIG. 1(a) may occur in two steps. The first step may be referred to as the forward problem, i.e., determining the raw speckle (image) given a particular particle distribution. The formulation of the forward problem is stochastic, treating the PSD as a probability density function which, in turn, determines the ensemble autocorrelation function of the raw speckle, as described herein. The second step may be referred to as the inverse problem, i.e., going backwards from the autocorrelation function to the PSD. Since this inverse problem is highly nonlinear and ill conditioned, an inverse module, such as one including a machine learning algorithm/model/module, may be used to solve the problem.

### Results on the Experimental Data Set

Some examples of test set results are shown in FIG. 4(a). The first column shows the corresponding ensemble autocorrelation for each set. The comparison between each prediction PSD and its corresponding ground truth is shown in the second column. FIG. 4(b) is the results from the disjoint validation set, which is to confirm the generalization ability of the model shown in FIG. 3(a). The DNN never meets these data during the training process, but still gives a good prediction on the cumulative distribution (the second column) and the PSD results. From FIG. 4(a) (i) (iv), FIG. 4(b) (i), the prediction at the small size side has may have more deviation than the big size end. This phenomenon can be interpreted by Equation (24), because

$$\frac{sin ( ru )}{u}$$

approaches 0 as r approaches 0, making it harder to distinguish at small radii.

As described herein, methods and systems have been provided that decode the size information in the speckle pattern quantitatively with the help of a physics-encoded inverse module, such as one using a deep neural network (DNN). The physical forward operator takes the form of the ensemble-averaged autocorrelation and it serves as Approximant input to the inverse module, such as a neural network. Such systems and/or methods method may be used to facilitate speckle processing in other applications of diffuse light imaging.

It should be understood that the subject matter defined in the appended claims is not necessarily limited to the specific implementations described above. The specific implementations described above are disclosed as examples only.

1. A method of monitoring a particle size distribution (PSD), the method comprising: illuminating a plurality of particles having a particle size distribution (PSD) by an at least partially coherent beam to produce scattered light;
capturing the scattered light by a pixelated photoelectric detector, thereby creating an ensemble of raw speckled images;
based on the ensemble of the raw speckled images, computing an ensemble-averaged intensity correlation;
providing the ensemble-averaged intensity correlation to an inverse module, the inverse module being configured to determine the PSD based on the ensemble-averaged intensity correlation; and
obtaining from the inverse module the PSD.

2. The method of claim 1, wherein the ensemble-averaged intensity correlation is an ensemble-averaged intensity autocorrelation.

3. The method of claim 1, wherein the inverse module comprises a machine learning module, a gradient descent module, a non-linear solver, a curve-fitting module, or a differential evolution algorithm module.

4. The method of claim 1, wherein the inverse module is configured to generate the PSD.

5. The method of claim 1, wherein the inverse module is configured to generate a cumulative distribution function (CDF) and to differentiate the CDF to generate the PSD.

6. The method of claim 1 , wherein the inverse module comprises the machine learning module.

7. The method of claim 6, wherein the machine learning module comprises a neural network.

8. The method of claim 7, wherein providing the ensemble-averaged intensity correlation to the inverse module comprises providing the ensemble-averaged intensity correlation to the neural network configured to determine the PSD.

9. The method of claim 7, wherein the neural network is a convolutional neural network.

10. The method of claim 9, wherein the convolutional neural network includes at least one skip connection.

11. The method of claim 9, wherein the convolutional neural network includes a plurality of stages, and wherein each stage of the plurality of stages includes at least one skip connection and at least one batch-normalization and activation layer.

12. The method of claim 9, wherein the convolutional neural network includes a linear layer.

13. The method of claim 1, wherein the plurality of particles is a dry powder, the method further comprising grinding the dry powder.

14. The method of claim 13, further comprising discontinuing grinding when the PSD shows agglomeration.

15. The method of claim 1, wherein the plurality of particles is a wet powder, the method further comprising agitating the wet powder.

16. The method of claim 15, further comprising discontinuing agitating the plurality of particles when the PSD shows agglomeration.

17. A device for monitoring a particle size distribution (PSD), comprising:
an illumination module adapted to illuminate a plurality of particles having a particle size distribution (PSD) by an at least partially coherent beam to produce scattered light;
a pixelated photoelectric detector configured to capture the scattered light and create an ensemble of raw speckled images;
a correlation-computing module configured to compute an ensemble-averaged intensity correlation based on the ensemble of the raw speckled images; and
an inverse module configured to determine the PSD based on the ensemble-averaged intensity correlation.

18. The device of claim 17, wherein the correlation-computing module is configured to compute an ensemble-averaged intensity autocorrelation.

19. The device of claim 17, wherein the inverse module comprises a machine learning module, a gradient descent module, a non-linear solver, a curve-fitting module, or a differential evolution algorithm module.

20. The device of claim 17, wherein the inverse module is configured to generate the PSD.

21. The device of claim 17, wherein the inverse module is configured to generate a cumulative distribution function (CDF) and to differentiate the CDF to generate the PSD.

22. The device of claim 19, wherein the inverse module comprises the machine learning module.

23. The device of claim 22, wherein the machine learning module comprises a neural network.

24. The device of claim 23, wherein the neural network is configured to determine the PSD.

25. The device of claim 23, wherein the neural network is a convolutional neural network.

26. The device of claim 25, wherein the convolutional neural network includes at least one skip connection.

27. The device of claim 25, wherein the convolutional neural network includes a plurality of stages, and wherein each stage of the plurality of stages includes at least one skip connection and at least one batch-normalization and activation layer.

28. The device of claim 25, wherein the convolutional neural network includes a linear layer.

29. The device of claim 17, further comprising a grinder adapted to grind the plurality of particles.

30. The device of claim 29, wherein the grinder is adapted to transmit the at least partially coherent beam for illumination of the plurality of particles.

31. The device of claim 17, further comprising an agitator adapted to agitate the plurality of particles.

32. The device of claim 31, wherein the agitator is adapted to transmit the at least partially coherent beam for illumination of the plurality of particles.

33. A computer program product for monitoring a particle size distribution (PSD), the computer program product comprising a computer readable storage medium having program instructions embodied therewith, the program instructions executable by a processor to cause the processor to perform a method comprising:
illuminating a plurality of particles having a particle size distribution (PSD) by an at least partially coherent beam to produce scattered light;
capturing the scattered light by a pixelated photoelectric detector, thereby creating an ensemble of raw speckled images;
based on the ensemble of the raw speckled images, computing an ensemble-averaged intensity correlation;
providing the ensemble-averaged intensity correlation to an inverse module, the inverse module being configured to determine the PSD based on the ensemble-averaged intensity correlation; and
obtaining from the inverse module the PSD.
